(19) United States
(12) Patent Application Publication
(10) Pub. No.: US 2009/0063234 A1
(43) Pub. Date: Mar. 5, 2009

(54) METHOD AND APPARATUS FOR CAPACITY MANAGEMENT AND INCIDENT MANAGEMENT SYSTEM

(76) Inventors: DAVID REFSLAND, Santa Monica, CA (US); Mark Long, Los Angeles, CA (US); Paul Dimitruk, Las Vegas, NV (US); Christian Maas, Los Angeles, CA (US); Tora Phan, Los Angeles, CA (US); Gary Olacsi, Tujunga, CA (US)

Correspondence Address: DLA PIPER US LLP, 1999 AVENUE OF THE STARS, SUITE 400, LOS ANGELES, CA, 90067-6023, US

(21) Appl. No.: 12/024,309

(22) Filed: Feb. 1, 2008

Related U.S. Application Data
(60) Provisional application No. 60/969,390, filed on Aug. 31, 2007.

(51) Int. Cl. G06Q 10/00

(52) U.S. Cl. 705/8; 705/7; 705/1

(57) ABSTRACT

The present system provides an automated and computer driven incident management system. The system can provide communication paths between responders or scan a network to determine when certain conditional tasks have been performed. The system can note when expected responders are not active and page backup responders or re-assign tasks to appropriate personnel to ensure adequate response to an incident. Updates to procedures can be done from a central location.

This application claims priority to U.S. Provisional Patent Application Ser. No. 60/969,390, entitled “Method and Apparatus for Capacity Management and Incident Management System,” and filed on Aug. 31, 2007, and is incorporated herein in its entirety by reference.

### BACKGROUND

1. Field

The system relates to the field of capacity management and incident management.

2. Background

Many operations and businesses have protocols and plans in place to deal with eventualities and circumstances that may arise. Sometimes these are referred to as crisis management protocols. However, that name may be misleading because not all circumstances that require advance planning are necessarily crises. Instead, a more appropriate term is incident management or incident response. In some operations, the responses and protocols to a particular incident may be determined by the enterprise itself, via pre-planning, working with a consultant or from prior experience of itself or other enterprises. In other instances, there may be third party requirements that must be met during an incident. These third party requirements may be from some other enterprise, such as an insurance company, and may be required so that certain rights are preserved that may be needed post-incident. In other cases, the third party requirements may be legal, mandated by statute or regulation, or other governmental requirement.

In most organizations, incidents require the coordinated response of many people. In the case of a time sensitive incident, such as an emergency situation, the coordination of these individual efforts may also have the complication of sequential order, meaning that some tasks must be started, in progress, or completed before other conditional tasks are initiated. It is common practice that organizations develop an “incident command structure” (ICS) that is responsible for planning for and coordinating during the response. Among the duties of the ICS is to outline the required roles and responsibilities of the individuals responding to an incident.

In current implementations, one method of providing for incident response is via the use of documents. This can be in the form of books, binders, or electronic forms of these documents that provide instructions to personnel on what to do in case of a particular incident. The user will pull a binder when informed of an incident, find the correct section of the binder that deals with such an incident, and proceed to follow a checklist of actions as appropriate for response.

In many situations, the execution of a task list for an incident response requires communication of one form or another with other responders. Particularly when some tasks are conditional, it is necessary that communication with those responders responsible for the conditional tasks be timely and clear. However, this is not always possible in some situations. For example, some emergency situations, such as a weather emergency, may interrupt or prevent the ability to communicate between responders.

In other situations, the task list may be locally conditional with instructions or tasks that may be skipped if certain conditions of the incident are present, or absent. However, this requires the responder to accurately read and follow the instructions on the task list, have all the necessary information to make that decision, and to not make wrong decisions while responding. This is not always possible.

It is often the case that the tasks to be completed are dependent on the responder's role within the organization or response team, their location, or their credentials.

Another problem with static document based incident management systems is the need to update the documents and binders as new protocols become implemented or required. This requires manually replacing or inserting new pages in each individual binder without mistake. If a binder isn't where it is supposed to be either during update or during the incident itself, inappropriate response is the result.

One typical enterprise that, has a need for incident management is a hospital. Many hospitals are operating at or beyond capacity, and living with severe cost and staff constraints. A minor mass casualty event or other incident (e.g., major traffic incident, chemical spill), one that damages the hospital's operating environment (e.g., a hurricane) or reduces its available staffing (e.g., Avian Flu), could overwhelm most hospitals. However, our communities, health and safety agencies, the Joint Commission on Accreditation of Healthcare Organizations and other constituencies look to hospitals to be the central community resource in responding to mass casualty events. Critically, the inability to respond in a timely, effective and comprehensive way affects the environment of care, not only for the casualties produced by the incident but also for the patients already admitted to the hospital as well as the health and safety of hospital personnel.

Hospitals can no longer handle disaster preparation and management using the old-fashioned paper-based “Disaster Binders,” which is the prevailing method of disaster management in the field of healthcare today. With the experience of large scale emergency events such as Hurricane Katrina and the new mandates for improved disaster management mandated by various agencies, hospitals need a better solution.

### SUMMARY

The present system provides an automated and computer driven incident management system. The system can provide communication paths between responders and can determine when certain conditional tasks have been or need to be performed. The system can note when expected responders are not active and page backup responders or re-assign tasks to appropriate personnel to ensure adequate response to an incident. Updates to procedures can be done on the fly if required. These communications, data sharing, and activities take place at multiple levels. Some of them are intra-facility and intra-organization and others are inter-facility and inter-organization.

The system provides interactive, best practice guidance for all stages of an incident: Preparation, Mitigation, Response, and Recovery. The system operates as an interactive work process tool that dynamically responds in real-time to the specific incident and role being performed by its user. It dramatically improves the tempo and quality of the response and reduces the risk of delay or error.

The system contains capacity management and data-collection tool that facilitates the tracking of supplies, personnel and critical components of the operating environment. The tool can be used on a routine basis, to support more effective day-to-day capacity management as well, as standing ready for when an “incident” occurs.

The system provides tools and guidance for all major constituencies, including disaster management professionals, staff, supporting personnel (e.g., environment services, material management), administrators, and can be configured to include others. The system provides managers with comprehensive situational awareness by enabling transparency into individual units (e.g., how many resources are at a particular location?) and supporting services (have requested repairs that could affect response been made?) The system also incorporates instant messaging and incident log communications tools that facilitate operations when other systems (cell phones, land lines) are overwhelmed or down. All of the actions, data, and communication during usage are collected for “after action” analysis and response improvement. During high tempo incidents, the system can be modified on the fly to incorporate new insights or developments (e.g., to add tasks to Job Action Sheets).

The system is flexible and designed to be configurable to the specific circumstances of individual enterprises as well as incorporate and automate compliance with national guidelines. Because all inputs are tracked and date and time stamped by user, substantial information for process improvement becomes available after drills and incidents. The system also provides guidance and tools for tracking and recovering expenses incurred during an incident.

### BRIEF DESCRIPTION OF THE DRAWINGS

FIG. 1 is a display illustrating the Response Dashboard

FIG. 2 is a chart illustrating an HVA (Hazard Vulnerability Assessment) exercise using the system.

FIG. 3 is an chart illustrating the capacity tracking feature of the system.

FIG. 4 is an input chart illustrating the specification of command center tasks.

FIG. 5 is an input chart illustrating the definition of tasks for the Mitigation Module of the system.

FIG. 6 is a display illustrating a JAS of the system.

FIG. 7 is an example of a task completion report for an incident commander.

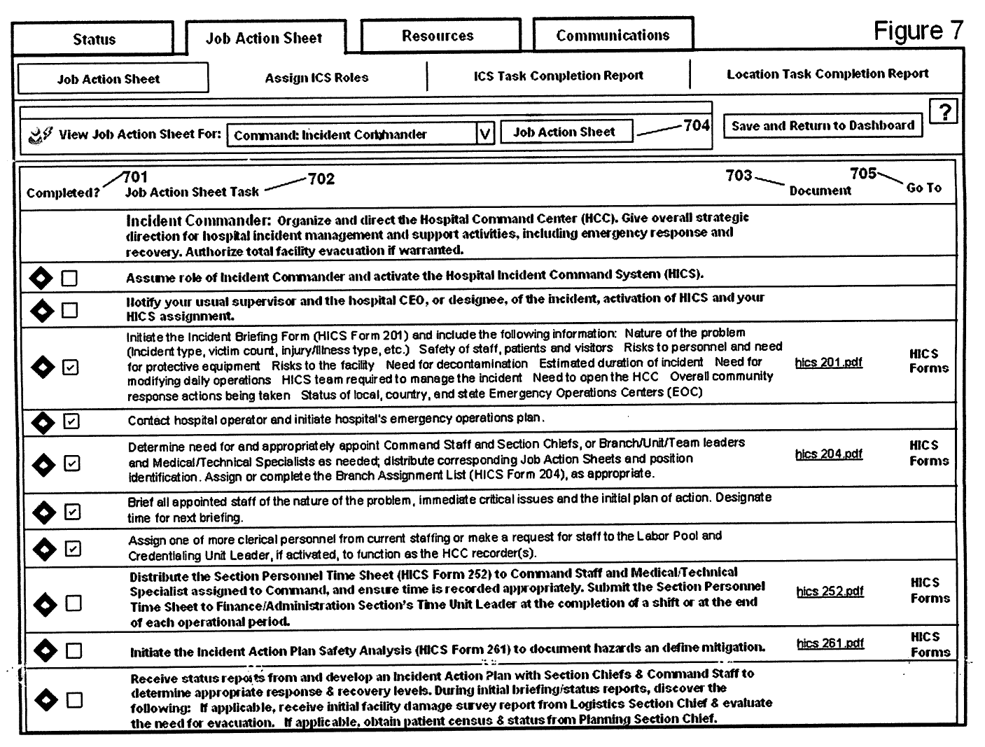

FIG. 8 is an example of a task completion report for ICS.

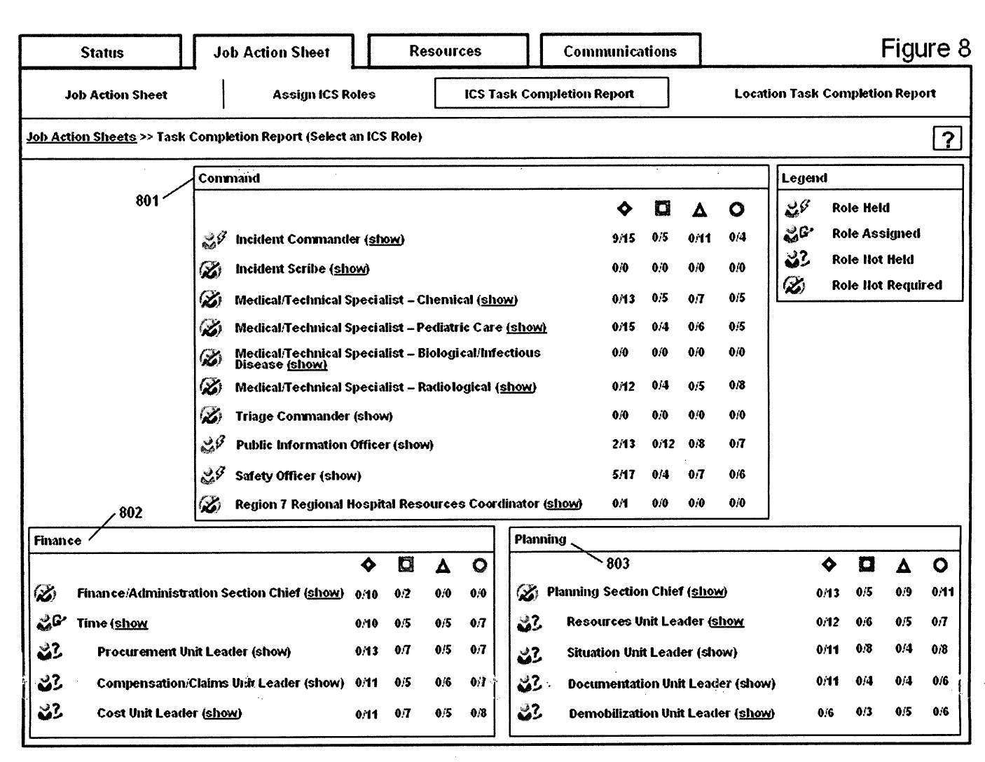

FIG. 9 is a graph illustrating asset data at another regional location.

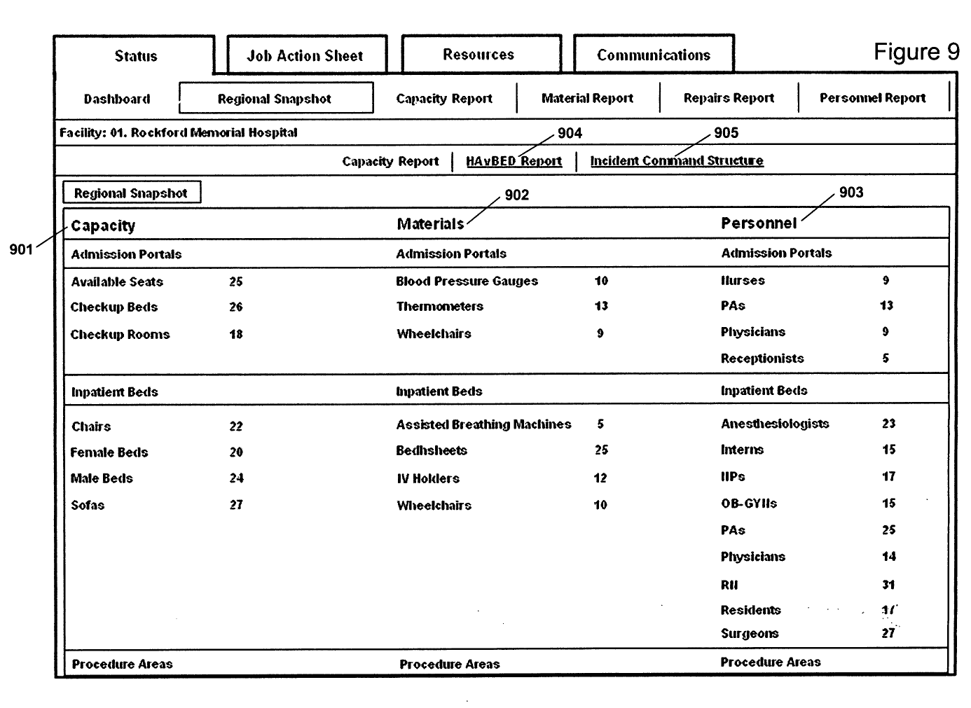

FIG. 10 is a table providing access to electronic versions of HICS Forms.

FIG. 11 is an electronic HICS IV form example.

FIG. 12 is a results chart of hospital capacity across time in the Recover Module.

FIG. 13 siteflow diagram illustrating all the modules of the system.

FIG. 14 is a siteflow diagram illustrating facility configuration using the system.

FIG. 15 is a flow diagram illustrating an embodiment of defining tasks.

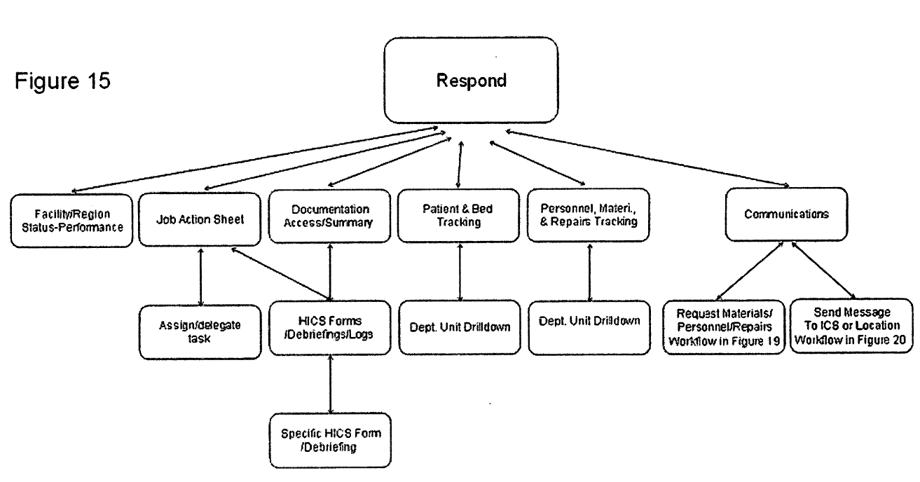

FIG. 16 is a flow diagram illustrating the operation of the Response Module in one embodiment.

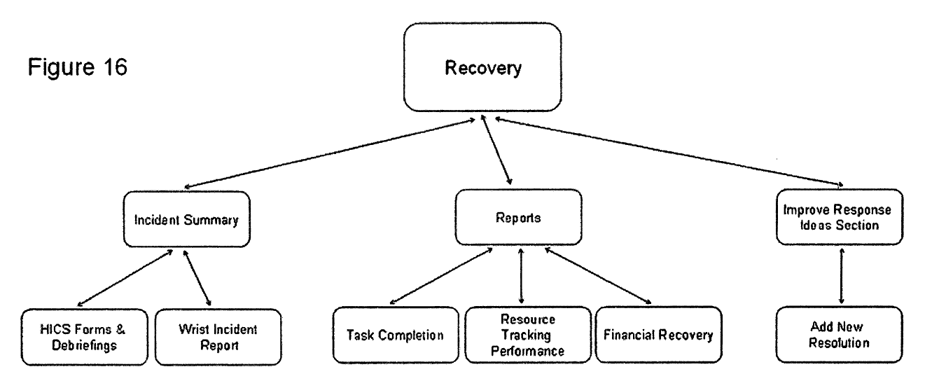

FIG. 17 is a flow diagram illustrating the initiation of the Response Module.

FIG. 18 is a flow diagram illustrating workflow involved in initiating a hazard response in the system.

FIG. 19 is a diagram illustrating communications workflow.

FIG. 20 is a diagram illustrating messaging workflow-replying.

FIG. 21 is an example of a report for an incident commander.

FIG. 22 is an example of a report for ICS.

FIG. 23 is a chart illustrating resource tracking in an embodiment of the system.

FIG. 24 is a map illustrating the geographical information systems display in an embodiment, of the system.

FIG. 25 is an example computer system of the present invention.

### DETAILED DESCRIPTION OF THE PREFERRED EMBODIMENTS

A method for capacity management and incident management is described. In the following description, numerous details are set forth in order to provide a more thorough understanding of the system. It should be understood that the system may be practiced without these specific details. In other instances, well known features have not been described so as not to obscure the system.

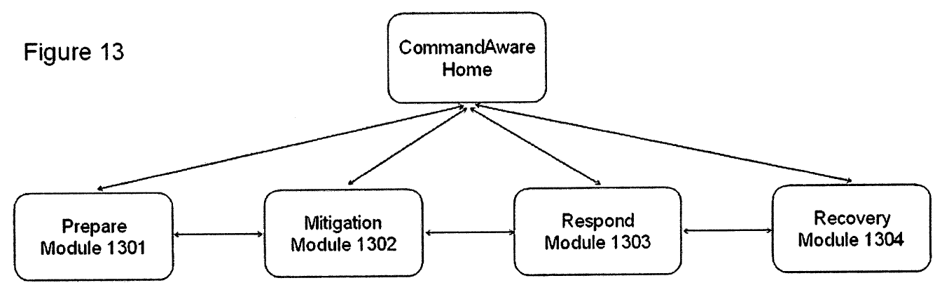

The system provides a computer and web based approach for incident management. In one embodiment, the system is configured in four modules illustrated in FIG. 13, Preparation Module 1301, Mitigation Module 1302, Response Module 1303, and Recovery Module 1304. Each of the modules may act as a stand-alone application, and also, may be interdependent with each one of the other modules. The following will describe in more detail each one of the modules. In the following description, the modules are described in conjunction with implementation in a hospital environment. This is by way of example only. It is understood that the system may be practiced in any suitable enterprise of environment and is not limited to hospitals or to the health care industry.

Preparation Module (1301)

In general, the Preparation Module 1301 serves one or more functions. It allows users to, for example, configure the system, do a vulnerability assessment, and create mitigation, response, and recover plans. Configuration may be based on at least one of: users, hospital ICS roles, facility(s) (or beyond one facility, to a multiple facility campus or hospital system) and organizational structure, hazards, job actions, or other categories. It also allows users to add to a reference library and associate those references with a particular hazard, role, task, event, phase of response, etc. References may include links, forms, screens, or attachments (e.g. documents, multimedia, spreadsheets, programs, etc). The Preparation Module provides a place to conduct a Hazard Vulnerability Analysis; and it allows users to specify steps for configuring at least one command center location.

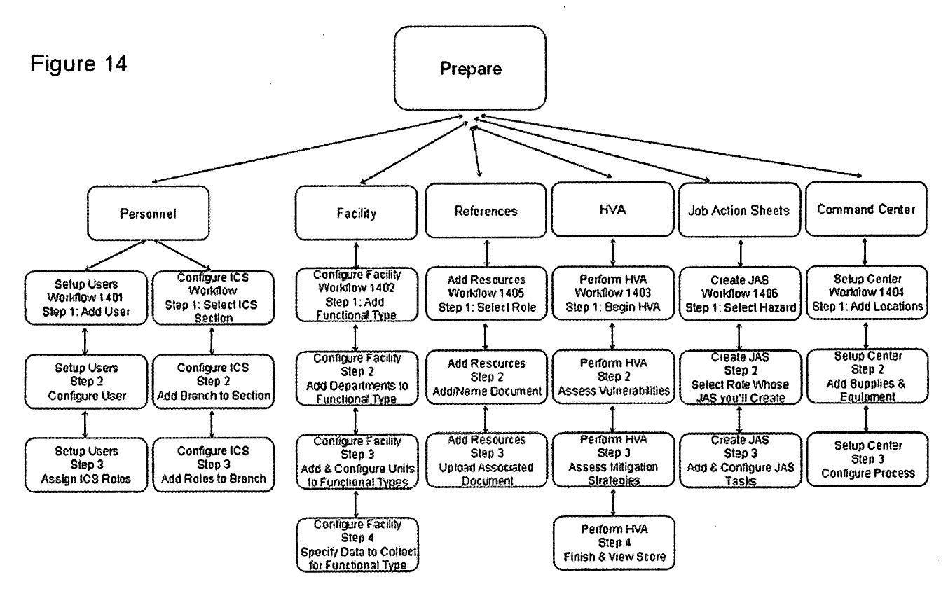

FIG. 14 is a siteflow diagram of one embodiment illustrating the operation of the Preparation Module, including workflows under each of the module sections. Two examples of the sections are “Personnel” and “Facility”. At workflow 1401 in the “Personnel” section, the system sets up valid users. At workflow 1402 in the “Facility” section, the system configures the facility where the system will be used (e.g. a hospital). Workflow 1403 initializes a Hazard Vulnerability Analysis. Workflow 1404 sets up a command center and workflow 1405 defines the document repository. Workflow 1406 defines Job Action Sheets.

User Setup (step 1401)

Workflow 1401A in FIG. 14 is a flow diagram illustrating the steps of setting up the users using the system. At step 1 members are added to the system. These are the people who will be responsible for certain tasks during an incident. For step 2 the system accepts a plurality of identifying information about the members including name, address, contact information, IM address, email address, pager, cell phone, position, location, and the like. In addition, the member is defined as being associated with one or more ICS role branches and/or committees that represent action groups of responders in step 3. (Note, a responder is anyone, employee or non-employee, who performs some task or job action regardless of whether this takes place during an incident or any other event). This step represents an important element, of the user setup and involves configuring what roles in the system the user is qualified to hold. In the “Command Center” section committee roles are added or defined. This associates with particular committee roles and functions that are the responsibility of that committee. A member of a committee is then automatically associated with that role. Examples of committees include Emergency Planning Committee and Emergency Management Committee.

In the Personnel section of the Prepare module the Incident Command Structure is defined. The Incident Command Structure is described in more detail below.

Incident Command Structure

The current state of the art in emergency management is to define, before an emergency occurs, an organizational chart that defines the roles and responsibilities each member of the response team needs to hold during an emergency. There are currently a number of incident command structure standards being used; the most relevant for hospitals are HEICS (Hospital Emergency Incident Command Structure) and NIMS (National Incident Management System and HICS (Hospital Incident Command Structure). HEICS and HICS is developed by a consortium of heathcare disaster management experts; NIMS is administered by the federal government under FEMA. An ICS as defined in NICS and NIMS is a collection of sections (command, operations, logistics, planning, finance, etc). Sections are a collection of branches, and branches are a collection of roles. Each Section has a Section Chief at the top of the hierarchy, that is not a member of a specific branch, but oversees all of them. The system may use these as a foundation, but allows for custom configuration per facility. HICS was developed to bring, together the hospital centric HEICS standard and the NIMS structure. The system is configurable to support other command, structures as required by each organization or industry.

In the system, the Incident Command Structure (ICS) is defined in workflow 1401B on FIG. 14 by the incident command structure roles, and hazard and role specific job action sheets (workflow 1406), (prioritized checklists of predefined tasks). The system may start with HICS as a foundation, but allows hospital users to configure the software to match their personal needs. For example, the system allows users to add roles or change titles in their incident command structure. The system further allows users to associate at least one ICS role with a particular request type.

Examples of common ICS roles include: the incident commander, director of security, chief of logistics, unit manger (per each unit), and many others. Each facility may add or remove an unlimited number of roles.

Further an incident can be categorized in “phases”. The most common of which is (1) Immediate, (2) Intermediate, (3) Extended, and (4) Recovery. The transition between phases can be based on time, conditions, or events. ICS roles can be activated or required based both on the type of incident or hazard as well as phase of the response.

Configurability (FIG. 14)

The system is configurable to particular facilities and users. Configuration may be based on at least one of: users, hospital structure, hazards, ICS, and job action sheets. The system may be preconfigured in several ways, in one embodiment HICS best practices are used as a baseline and each facility can modify the system to suit their individual needs.

Facility Configuration

In one embodiment, the system can be configured based on a particular facility using the system (workflow 1402 in FIG. 14). In this embodiment, a user can setup their facility by adding or removing departmental units to functional types. A user can add one or more units to each one of the functional types in the facility. Each unit can be configured with additional information, such as, for example, phone number, location, etc.

FIG. 14 also shows a workflow (1402) illustrating facility configuration using the system. At step 1 a Functional Type is defined. In this method of describing hospital units a facility is a collection of functional groups or types. Examples of this are inpatient beds, procedural areas, and admission portals. A functional group is a collection of departments. Examples of inpatient bed departments are: Intensive Care Units, Medical-Surgical beds, Psyche beds. A department is a collection of units. A unit is a collection of hospital beds, personnel, or materials/equipment. The bed items can be of different types, including burn beds, Intensive Care Unit beds, medical surge beds. They can also be divided by sex, i.e. male beds, female beds. Examples of Intensive Care Units are Cardiac Intensive Care Unit and Pediatric Intensive Care Unit Non-traditional locations can be added on the fly. During Mass Casualty Incidents, areas such as football fields, cafeterias, hotels, etc may be used that are not part of the everyday patient care location structure in the hospital, but that must still be tracked. These areas are known as Surge Areas.

At step 3 of workflow 1402 the descriptions for each unit for each department are defined. This is a brief description of the unit followed at step 1304 by a summary of the unit descriptions. In a hospital environment, units may include bed count, hall capacity, contact information, personnel, and other related information. At step 1305 unit data collection is defined. This is a list of all the data that is to be requested from the unit during incidents or other times. Additional data collection definitions may be provided as well. A summary of the data collection defined is presented at step 4 for additional editing or acceptance in workflow 1402.

Hazard Vulnerability Assessment (Workflow 1403)

A Hazard Vulnerability Analysis (Workflow 1403) is an analysis that helps hospitals identify which disasters are most threatening to their particular institution, so that they can make better decisions in planning for disasters. Currently, JCAHO, the Joint Commission on Accreditation of Healthcare Organizations, requires that a hospital perform a hazard vulnerability assessment (HVA) yearly at a minimum.

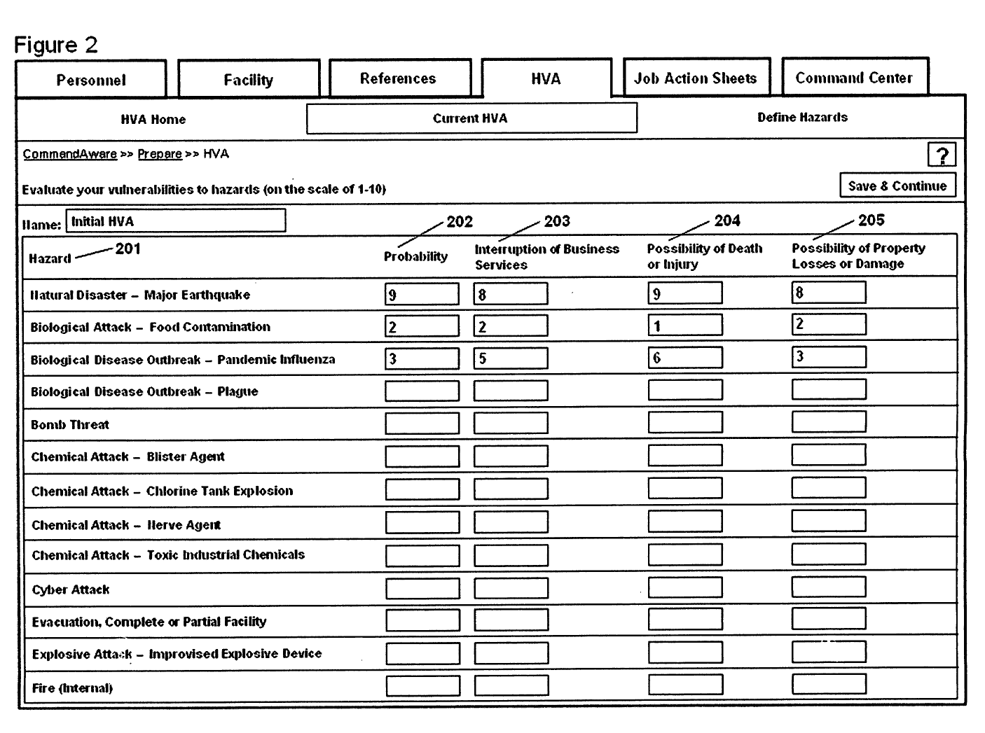

The system provides users with an ability to conduct an HVA. In one embodiment, users rank disasters from a previously specified list on a number of different metrics. Such metrics may include, for example, the categories which reflect the likelihood of interruption of business services, the possibility of death or injury, and the probability of property loss. To conduct an HVA, the user assigns numeric values to at least one metric. In an alternate embodiment, values may be non-numeric, but, for example, may consist of any other kind of input, such as for example a choice of words, or phrases (high, medium, low, etc.). FIG. 2 illustrates an embodiment of how this could be implemented. The user is presented with a chart to evaluate perceived vulnerability to hazards. The chart includes a column of hazards 201 (e.g. biological agent, blizzard, bomb threat and the like). The user can then rank each hazard on a scale of 1-10 for a variety of factors including probability 202, interruption of business services 203, possibility of death or injury 204 and possibility of property losses or damage 205. As can be seen from reviewing FIG. 2, an earthquake scores high in all of these categories while an food contamination relatively low.

The system's HVA feature then calculates a threat score for each hazard based on user input and pre-defined logic. Hazards are then ranked accordingly, based on the user's vulnerability to the hazard.

Command Center Configuration (Workflow 1404)

The system further allows users configure a command center as described in workflow 1404. Configuring a command center includes specifying a command center location or locations. The location may be designated as a default command center location. Users can further specify a list of equipment and/or supplies that should be present in each command center location.

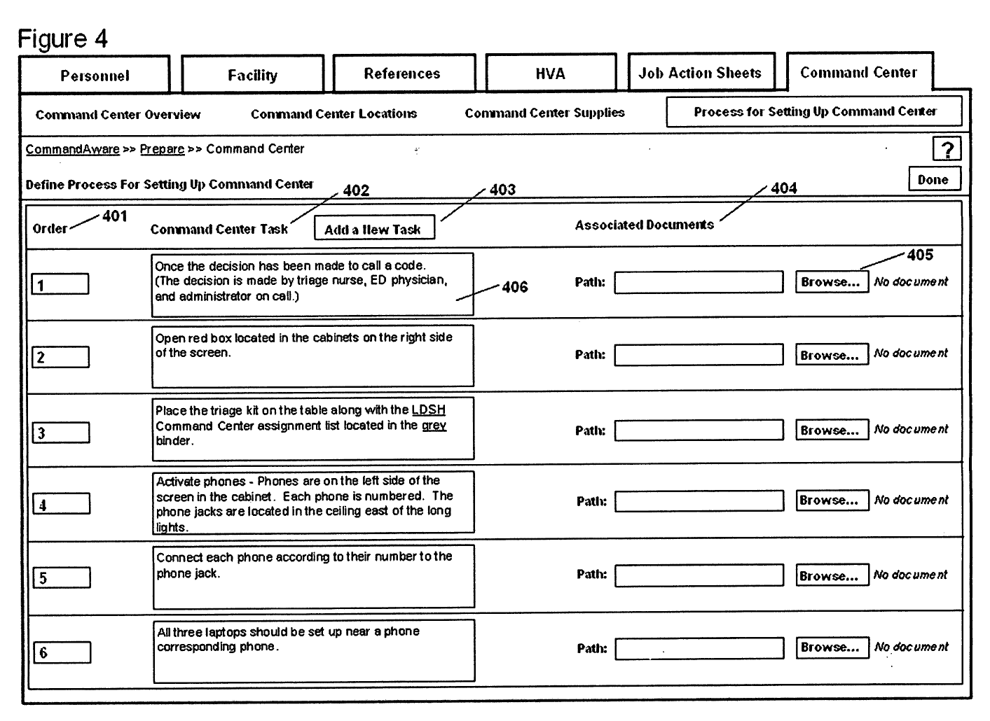

In a further embodiment, the user can specify a process for setting up the command center location. This is the process to be followed when there is a need to set up a command center, such as, for example during a hazard. Defining the process for command center location includes specifying steps or tasks, assigning them an order, and uploading any references associated with any such step. FIG. 4 is an input chart illustrating the specification of command center tasks. The chart includes a column 401 for dynamically configuring the order in which tasks are to be executed. Column 402 presents the command center tasks and column 404 presents associated documents for each task. If a user needs to add a task, the “Add a New Task” button 403 is enabled. For each task, there is a text entry region 306 where the description of the task is entered. During operation, the task can be presented to the user in order so that the response can go according to the book, without the book. Certain tasks may have associated documents that are required. When creating a task, a browse 305 capability is provided to find and link the appropriate document to the task.

References/Resources Library (Workflow 1405)

The system provides the ability for users to upload or specify references (workflow 1405). These references are then displayed to and can be accessed by other users of the system. References may include, but are not limited, to written documents, graphs, pictures. PDF documents, Excel spreadsheets, multimedia files, and website links. In one embodiment, each reference is accompanied by an option to enter a description for the reference.

In one embodiment, users may associate references with specific ICS roles. In another embodiment, users may associate references with a particular hazard. In a yet further embodiment, users may add references to specific tasks in the various JAS.

In one embodiment, users may upload or specify references such as general references, phone books, contact information, or the like. Contact references, for example, may include facility's internal phonebooks, phone numbers for other hospitals, governmental entities, or suppliers and vendors.

Uploaded references can be used by the system users in a response to disaster, in preparing for a disaster, or in reviewing post-disaster documentation. These references may be displayed on the computer screen, saved, or printed out.

In one embodiment, users upload or specify references in the Preparation Module of the system. The references are then displayed in appropriate places in the Response Module. In a further embodiment, references may be uploaded or specified in the Mitigation and Recovery modules. In a yet further embodiment, Response Module provides a place for users to upload or specify references.

Data Collection Configuration

In a further embodiment, the user's facility can be further configured for data collection. In this embodiment, the user can specify one or more items to be tracked by all departments. Such trackable items, in one embodiment, consist of staffing levels and area capacity items. Examples of staffing levels include: available nurses, technicians on staff, doctors on call, etc. Examples of area capacity items include: equipment (ventilators, etc), supplies (medications, blood supplies by type, etc), empty beds (optionally by bed type), dirty beds, patients, patients from the current incident, missing patients, ghost beds, etc.

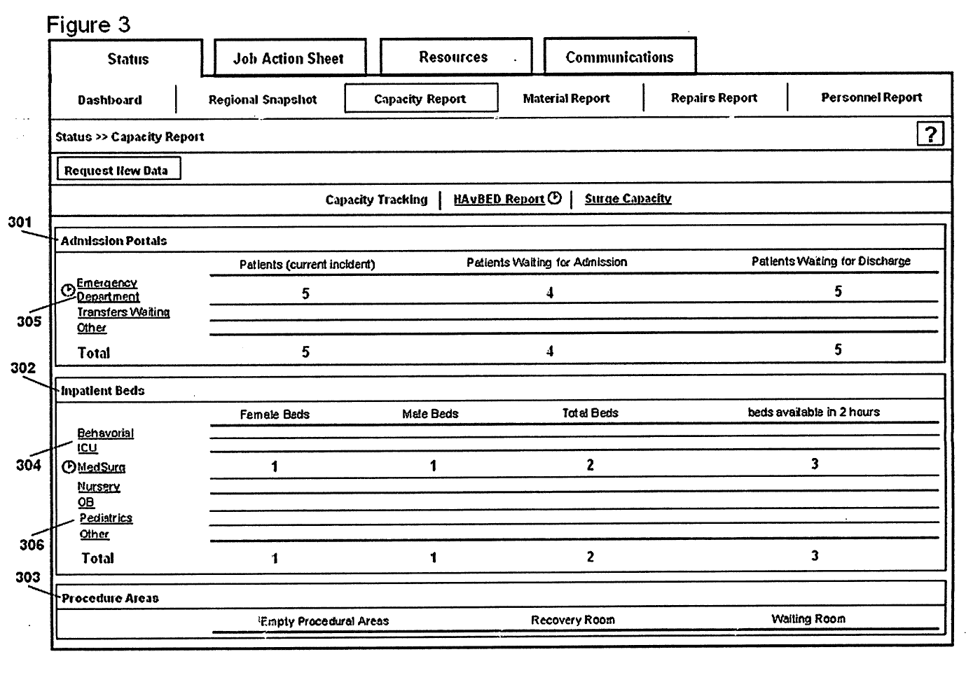

In yet another embodiment, data-collection configuration may be a two step process. In the first step, the user defines items to be tracked by all departments. In the second step, the user defines additional items to be tracked by specific departments, on a department-by-department level. In further embodiments, users could also specify additional items to be tracked on the per-unit level This data-collection configuration is used in the Response Module of the system during data-collection. As will be discussed in more detail below, hospital units and/or departments will report data on the items that are to be tracked for each unit. FIG. 3 is an input chart illustrating a data tracking feature of the system. The input chart includes functional sections for bed capacity data (301, 302, and 303) along with a plurality of locations for each including Behavioral ICU 304, Emergency Department 305, and Pediatrics 306. By selecting a link in the left most column, the user is presented with a data entry page for that unit that allows them to enter or edit existing data as desired.

Job Action Sheets (Workflow 1406)

A user can configure the system by assigning a list of tasks to any number of ICS roles. These tasks are called “Job Action” items. A list of these tasks is referred to as a “Job Action Sheet” (JAS). The user can further configure the system by assigning additional tasks to any number of ICS roles based on a specific hazard, location, phase of response, etc. For example, an incident commander (which is an example of an ICS role) may have X number of tasks that are to be performed in all emergencies (i.e. “All Hazard Tasks”). The incident commander may then have additional Y number of tasks that are to be performed in an Earthquake Hazard and an additional Z number of tasks to be performed in a Flood Hazard. If an Earthquake Hazard were to be activated, the system would then know that the incident commander has X+Y tasks and may, in another embodiment, notify the incident command that there are X+Y outstanding tasks to be performed. If a Flood Hazard was activate, the system would then have X+Z tasks for the incident commander. If, in another example, the Earthquake and the Flood Hazards were activated, the incident command would have X+Y+Z tasks. In each one of these examples, the list of tasks, the JAS, for the incident commander, would be a combined list of the all-hazard tasks and tasks associated with the activated incident or incidents.

All-Hazards Approach

Most emergency management plans that employ some sort of Incident Command Structure take what is known as an “all-hazards” approach to developing their job action sheets. That is, each role defined in the ICS has a list of tasks that need to be performed in all emergencies, regardless of the type of emergency. The system may be configured for the same approach.

The system supports an “all hazards” approach by allowing a hospital user to define a list of tasks each role has to perform regardless of the kind of hazard. A unique aspect of the system that separates it from other ICS systems is the ability to define additional tasks specific to the type of the emergency that members of the ICS have to perform. This allows hospitals to tailor their emergency management plan to specific types of emergencies.

Mitigation Module (1302)

The Mitigation Module of the system provides one or a collection of customizable task lists. It allows users to customize and manage a variety of tasks. Such tasks may consist of, but are not limited to: tasks related to financial matters, tasks related to materials, tasks related to vaccines, tasks regarding personnel training, tasks related to structural issues, or other general mitigation tasks. One goal of the Mitigation Module of the system is to provide a list of tasks that, when performed, would help mitigate a facility's threat or exposure to a particular hazard. For example, in order to mitigate a threat of an earthquake hazard, a user may define retrofitting the facility's roof as a structural task for the earthquake hazard. Other tasks might be defined to improve response, such as pre positioning of command center materials at a primary and backup command center or preparing an emergency action plan with an external supplier.

Creating and Managing Tasks

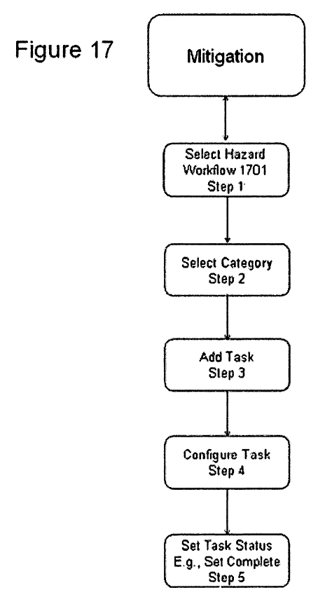

In one embodiment, the process of creating or customizing mitigation tasks is illustrated in the workflow diagram of FIG. 17. At step 1, users choose or indicate a particular hazard for which they want to manage tasks. At step 2, users indicate the category of tasks the users wish to edit. For example, a user wanting to add “retrofitting the roof” as a task would specify that it should go under the earthquake hazard, in the category of structural tasks. At steps 3 and 4, users edit or create the tasks by specifying its attributes.

In an alternative embodiment, tasks may be managed simply by associating them with a particular hazard, without having to associate them with a task category. In yet another embodiment, a list of tasks may be a stand-alone list intended to mitigate the overall threat of a disaster to a hospital.

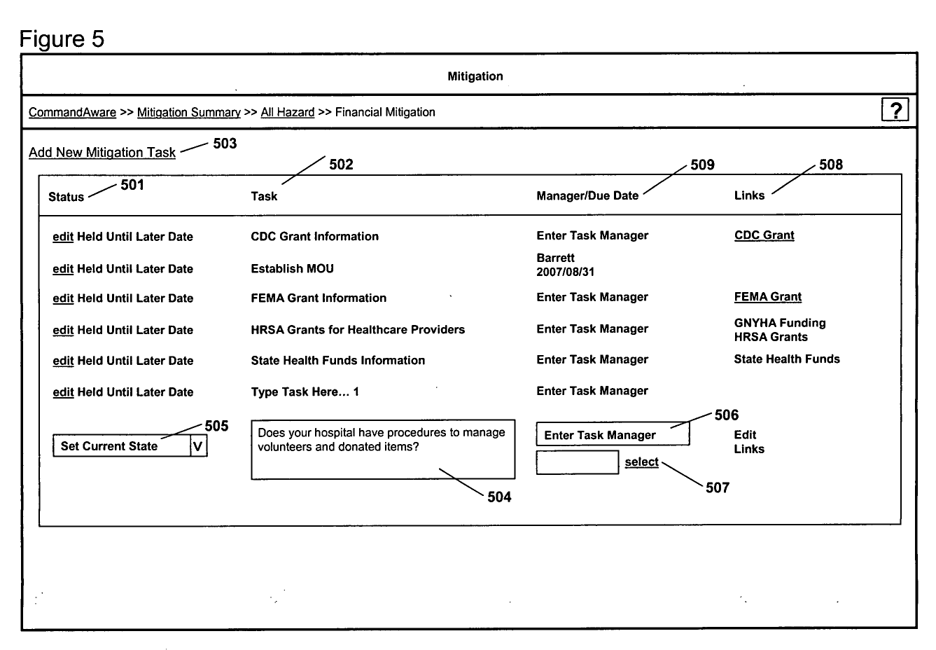

The mitigation task attributes consist of at least one of the following: the task description, the task due date, task supervisor, task priority level, task rating or rank, and the person or entity to perform the task. FIG. 5 is an input chart illustrating the definition of tasks for the Mitigation Module of the system. The associated task status is indicated (and can be selected) at 501. Column 502 includes one or more mitigation tasks. A new task can be added by using link 503. The mitigation task is defined in text entry box 504. A selector 505 indicates the status of the mitigation task. The manager and completion elate are customizable and are indicated at 506 and 507 respectively. Links associated with the task can be added in column 508.

Task Customization & Status

A task should contain at least one attribute. The at least one attribute may consist of a task name or a task description 502. Additional attributes for a task may contain information such as the task supervisor 509, a task completion date 507, support links 508, and task status 501.

In presenting a task list to the user, the list of mitigation tasks may be organized or presented to the user based on task status. In a further embodiment, task date and task status are used to dynamically generate the task lists. In further embodiments, task date and task status may be used to dynamically generate alerts. For example, a specified time before the hurricane season at a particular facility, an alert may be generated regarding that facility's mitigation tasks associated with the hurricane hazard.

All-Hazard Approach

In one embodiment an all-hazard approach is used in generating a mitigation task list. The task list for a hazard will consist of all mitigation tasks assigned to “all hazards” hazard plus the mitigation tasks assigned to the particular hazard. This is called an “all-hazard” approach.

Response Module (1303)

The Response Module 1303 of the system is intended to be used in association with a hazard when it occurs. In one embodiment, the Response Module provides functionalities such as:

1. Dynamically generated JAS based on an activated hazard, ICS role of the user, location of the user, phase of the response, user defined filters, and, in one embodiment, may include an all-hazard approach.

2. Communication/Messaging

3. Incident log;

4. Trackable requests;

5. Data sharing both within a facility and across facilities within a defined group, e.g. geographic region, hospital system, etc.;

6. Reference library; and

7. Data collection (capacity management),

Operation

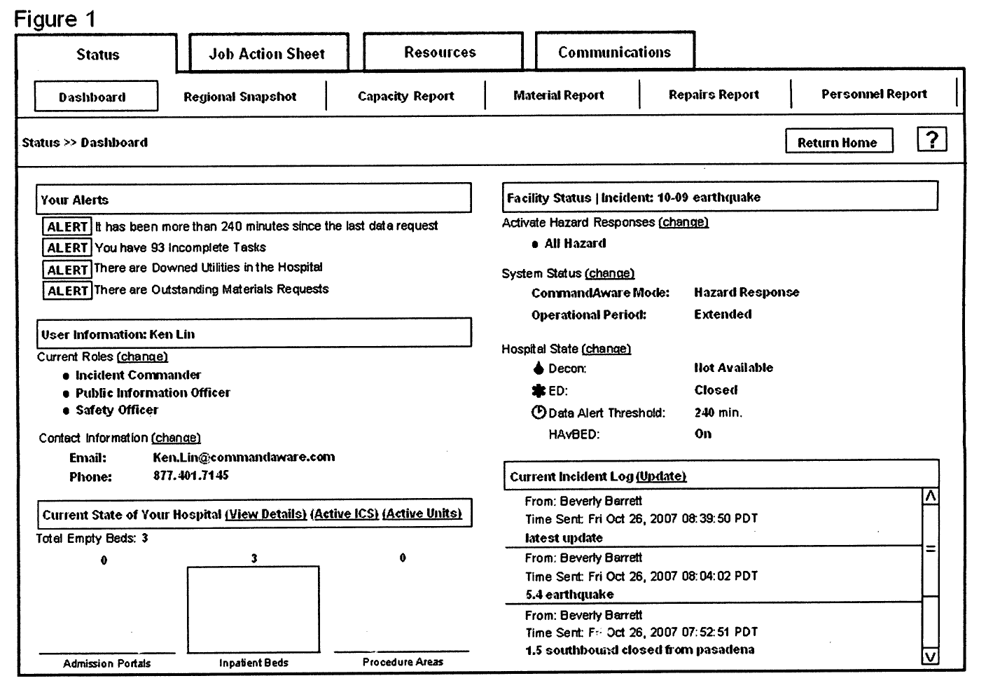

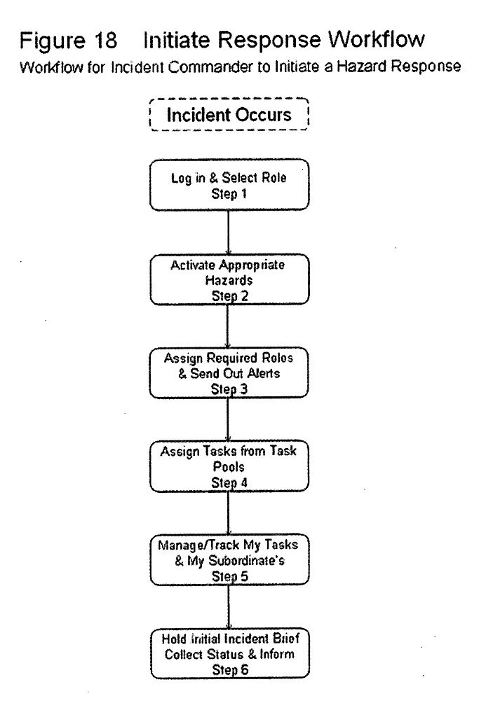

The workflow involved in initiating a hazard response in the system is illustrated in the flow diagram of FIG. 18. When an incident has occurred or is anticipated, an incident commander selects the incident response mode (step 1) and identifies the incident from a complete “All Hazards” menu to initiate the Response Module at step 2. Everyone on the system then receives appropriate alerts (email, pager, sms, etc as configured for each person), an incident-specific job action sheet (step 3) customized to their role and their own “Dashboard” (FIG. 1) that provides the tools and information they need to perform effectively in their role. The incident commander (IC) can modify information provided and collected “on the run” during the course of the incident through the Preparation Module. The system provides the IC with real time information, including:

Personnel signed on and using the system, their location, and role

Complete contact information for all relevant personnel

Status of job completion for each role and task

Requests for supplies, equipment, personnel and repairs

Resource availability by individual unit

Incident log entries

System and regional level status across multiple facilities

Access to relevant documents, and

Links to relevant sites, e.g., CDC, WISER, FEMA, State Agencies

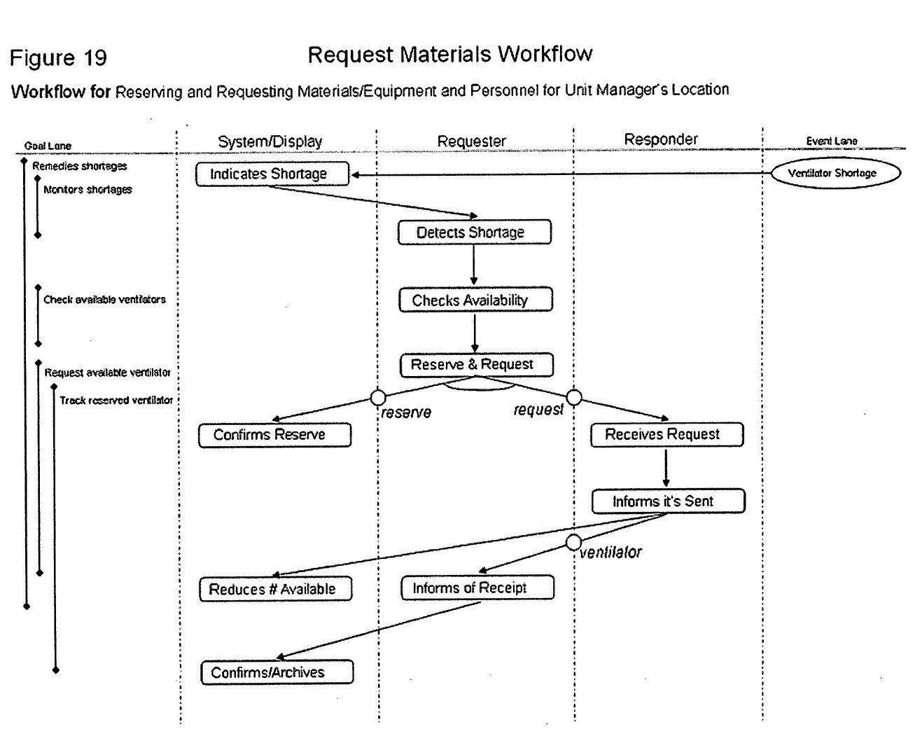

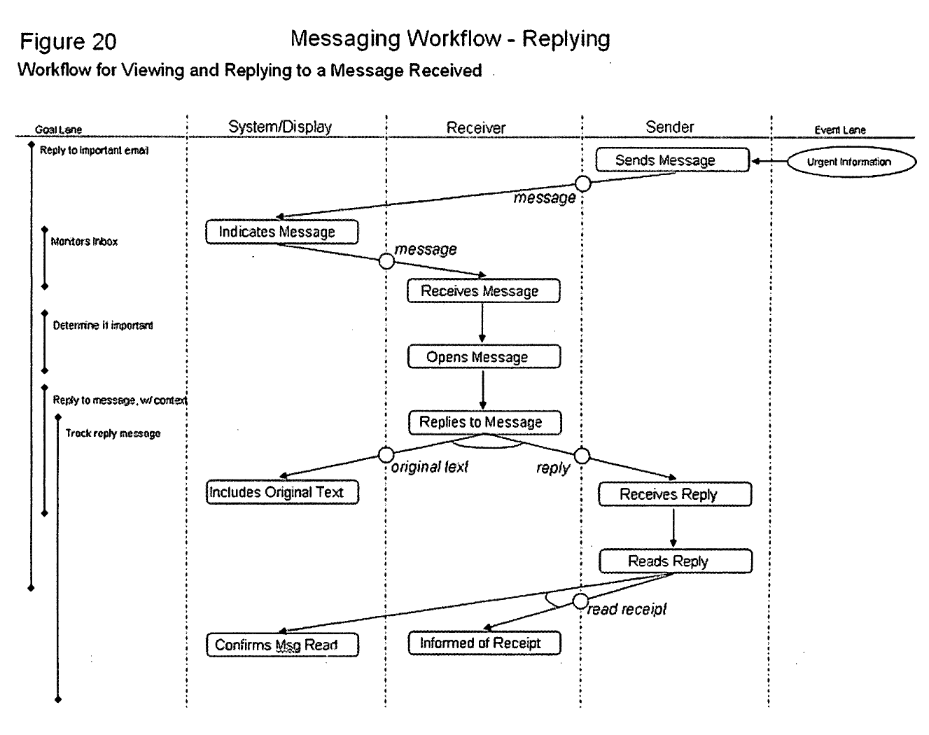

Each facility unit and function (e.g., materials and supplies, environment services, engineering and logistics) has its own dashboard through which relevant alerts and requests are channeled and information is accessible. Communications are routed by the system (workflow in FIGS. 19 and 20) using one or more of the communication schemes described below. Units can use the system to request supplies, equipment, personnel and repairs. Each request is electronically stamped, with date, time and sender, is routed as an alert to the appropriate function (e.g., engineering), and remains on the function's dashboard alerts panel until the request is fully processed and the requesting unit records an acknowledgement. The system maintains an archive of all activity and communication. In one embodiment of workflow routing as shown in FIG. 19, the system indicates a shortage. A requester detects the shortage, checks availability, and makes a reserve and request. The reserve goes to the system and the request goes to a responder. The responder receives the request, and informs the system and recipient when the request is sent. The system updates inventory and confirms the action in its archives. At FIG. 20 a sender creates and sends a message with urgent information. The system indicates a message and sends it to a receiver who receives, opens, and replies to the message. The message is sent to both the system and the first sender who reads, the message with read receipts being sent to the receiver and system.

In a further embodiment, the Response Module may also be operated in an every-day mode. All functionalities of the Response Module may be provided in the every-day mode. However, hazard auditing functions of the Recovery Module may not be available where collection of such data would not make sense without an active hazard.

FIG. 18 is a flow diagram illustrating the operation of the system in initiating the response module (step 2). At step 3 a commander or supervisor uses the system to select the hazard for which a response is required. The system then retrieves the current state of the facility (personnel resources, and the like). At step 4 the system populates a list or responders based on the facility data. There may be pre-assigned roles to personnel during a particular hazard. If all needed responders are not available, the system can assign personnel to responder positions based on qualification, or another defined hierarchy, which may include statutory or regulatory requirements. In some cases, the lack of an appropriate person to fill a particular responder's role may require doubling up the duties of some personnel or the automatic notification of third party responders so that required functionality can be provided. Users may hold multiple roles.

At step 6 the system defines communication paths appropriately so that communication between responders can be implemented. As noted below, communication can be to a person, to a responder role, to a department, location, or the like, even when the communicators do not necessarily know the identity of the current responder in position. This routing of communications insures that message traffic gets to the right place with minimal searching by the responders. The system also dynamically generates the jobs that will be required for the hazard and assigns them to the appropriate responder based on personnel and other facility resource status.

Communication—Messaging

The system provides a system for sending information from one user to another (referred to here as “messaging”). The messaging system comprises a sender, a recipient, and a message. These communications take place at multiple levels. Some of them are intra-facility and intra-organization and others are inter-facility and inter-organization.

The sender of the messaging system is the system or user sending a particular message. In one embodiment, the sender is identified by the name of the user or the user's login name. In another embodiment, the sender is identified by the ICS role(s) the user is holding (or is authorized to hold). In yet another embodiment, the sender may be identified by their location within the facility. For example, if Mr. Brown, a chief of security logged in from ICU, sends a message to the incident commander, the message received by the incident commander may indicate that the sender was Mr. Brown, the chief of security, the ICU, or all three identifiers. For inter-facility or inter-organization communication identification of the facility and organization is also included.

The recipient of the messaging system may be specified based on one of the following: ICS role, location within the facility, user name, or another category, in one embodiment, the system provides at least two modes of choosing recipients for messaging. The at least two modes of messaging include a “location-based messaging” mode and a “role-based messaging” in addition to user name based messaging. For inter-facility or inter-organization communication identification of the facility and organization is also specified.

The “location-based messaging” mode allows messaging to/with a specific facility location. In this embodiment, the sender of the message chooses a particular location within a facility as a recipient of the message. Once the message is sent, it is delivered to at least one of the following: a user logged in from the chosen location, a user responsible for the chosen location, multiple users logged in from the chosen location, or the users responsible for the chosen location. To illustrate, one user of the system may be a nurse unit manager for the ICU unit. When a message is sent to the ICU using the “location-based messaging” mode, the nurse unit manager for the ICU is the recipient of the message. For inter-facility or inter-organization communication identification of the facility and organization is also specified.

In one embodiment, the list of available locations contains only those locations which are presently logged on. In other embodiments, if no user is logged on from the location selected as the recipient, the message may be delivered to one or more of the following: the role or roles responsible for the recipient location, the incident commander, the users which are authorized to log in from the recipient location (even if they are currently logged on from a different location). Alternatively, the message may be stored and delivered to the recipient location when a user logs on.

The “role-based messaging” mode allows messaging to/with a recipient to be determined by a specific ICS role. In this embodiment, the recipient list comprises the various ICS roles available or existing at a particular facility. The user wishing to send a message chooses a role based on the ICS of the recipient's facility. The message is delivered to the user holding the chosen role. To illustrate, a user of the system may choose to send a message to the incident commander, which is one ICS role. Once the message is sent, it is delivered to the person or persons presently holding the incident commander role in the system. For inter-facility or inter-organization communication identification of the facility and organization is also specified.

If no user holding the selected role is logged on to the system, the message may foe delivered to all persons logged on to the system who are authorized to hold the selected role. Alternatively, the message may be delivered to the first person to log on to the system with the selected role at the time that they log on. In a further embodiment, the user may be notified that the selected role is not logged on and that the message cannot be sent. In yet another embodiment, the list of the roles the message cart be sent to is limited to only those roles that are presently logged on to the system.

During an incident the personnel holding these roles may change. As new or additional personnel take on new roles, all communications to that role will be immediately available to them.

The message of the messaging system comprises at least one of the following: a message heading, a message text or body (containing text stylized or not), a reference attachment (a document, a hyperlink, or any other reference), a priority or rank, a signature block, and a date and time stamp. The message may also include other information regarding the status of the system, such activated hazards, the location of the sender, etc.

The message maybe sent within the system, or dispatched over alternative communication systems, e.g. telephone, mobile phone, email, pager, SMS, etc. Responses to the messages my also be entered directly into the system, or by interface to any communication medium. The reply need not necessarily be provided via the same communication mechanism as the message. A user could receive a voice message and reply via voice, keypad, or some other communications means.

Incident Log

In one embodiment, the system provides an incident-log for an incident. The incident log is similar to a message board, where users may leave messages. In the preferred embodiment, users may leave a message, which will then show up in the incident log, visible to other users. An entry in the incident log consists of at feast one of the following: a message, a time of the posting, the name of the poster, the role the poster was holding at the time of the posting, the role the poser is holding presently, and the body of the message provided by the user. In a further embodiment, the incident log may contain messages or posts containing news articles or information regarding the present incident that may be useful to the system users. Incident log content may come from users or internal or external data sources such as databases, data feeds, web services, RSS, and the like.

Trackable Requests

The system allows users to submit one or more requests. The system also tracks requests through the request-fulfilment process.

A request comprises at least a sender and a request message. In the preferred embodiment, the request further comprises a request type. The request type may be one of: requests for repair, personnel requests, logistic requests, and requests for materials. In further embodiments, additional request types may be specified.

In one embodiment, a request recipient is automatically selected by the system based on the request type. In this embodiment, the system may be configured to route specific types of requests to particular ICS roles. (This is configured in the Prepare Module). In the Preparation Module of the system, users are able to associate at least one ICS role with a particular request type.) The recipient of the request is then automatically selected by the system based on the type of the request submitted and the existing configuration. For example, the system can be configured so that the logistics requests go to the role of the logistics chief (which is one of the ICS roles). If a user submits a request specifying that it is a logistics request, the request will then automatically be routed to the logistics chief.

In one embodiment, to submit a request, the user will select a request type. A user will then fill in various information relating to the request. In an alternative embodiment, the user may select the request type at any time before or while submitting a request.

The information relating to the request may include a title of the request, a request description, a number of units being requested (for example, the number of personnel that is needed), a location of the request and/or the need, a priority and/or severity of the request, or any other feasible information. Once the request is filled out, the user will submit it. In the preferred embodiment, the request is routed to an ICS role. In an alternative embodiment, the user may specify additional recipients for the request.

In one embodiment, the system tracks requests until they are cleared. Once the request is submitted, the recipient will receive it. Upon receiving the request, the recipient may mark it as “received” or any other similar notation. A status of the request will then accordingly indicate that it has been received. Once the recipient of the request performed the necessary actions to fulfill the request, the user may mark the request “fulfilled” or any other similar notation. The status of the request will then accordingly indicate that it has been fulfilled. Lastly, the sender of the request may acknowledge that the request has been fulfilled and mark the request “cleared”, or any other similar notation. The status of the request will change accordingly.

The status of the request in the preferred embodiment can be seen in a number of places. One, the user sending the request may see its status through in a request log, comprising a log of sent requests. Recipient of the request may see its status in a log of all incoming requests. Other users of the system may see all outstanding requests and their status from a requests overview section of the Response Module.

Dynamic Job Action Sheets

A Job Action Sheet (JAS) is a list of tasks to be performed by a particular member, user, or role during an incident response. In one embodiment, each JAS depends on the ICS role the user is holding, as well as on the activated hazards, location, and/or phase of the response. In other embodiments, JAS are dynamically generated based on at least one of: the activated incident, the ICS role held by the user, and an all-hazard JAS. That is, for example, an incident commander's task list will be different than a security chiefs task list, and the incident commander's task list for an earthquake may be different than the incident commander's task list for a flood. The system recognizes which hazard or hazards have been activated, and dynamically generates a JAS based on tasks associated with each of the activated incidents, and, in one embodiment, the all-hazard tasks. The Job Action Sheets can and will change over time based on the evolving incident, activities of other people, etc. Each time a user requests their JAS the system will update it based on the available data.

In one embodiment a user can delegate tasks on their JAS to other members of the team. In one embodiment, the recipient of a delegated task has the option to accept or reject the delegation of the task. One configurable parameter set allows the system to determine the authority of the current user and only allow delegation based on hierarchy or incident comment structure.

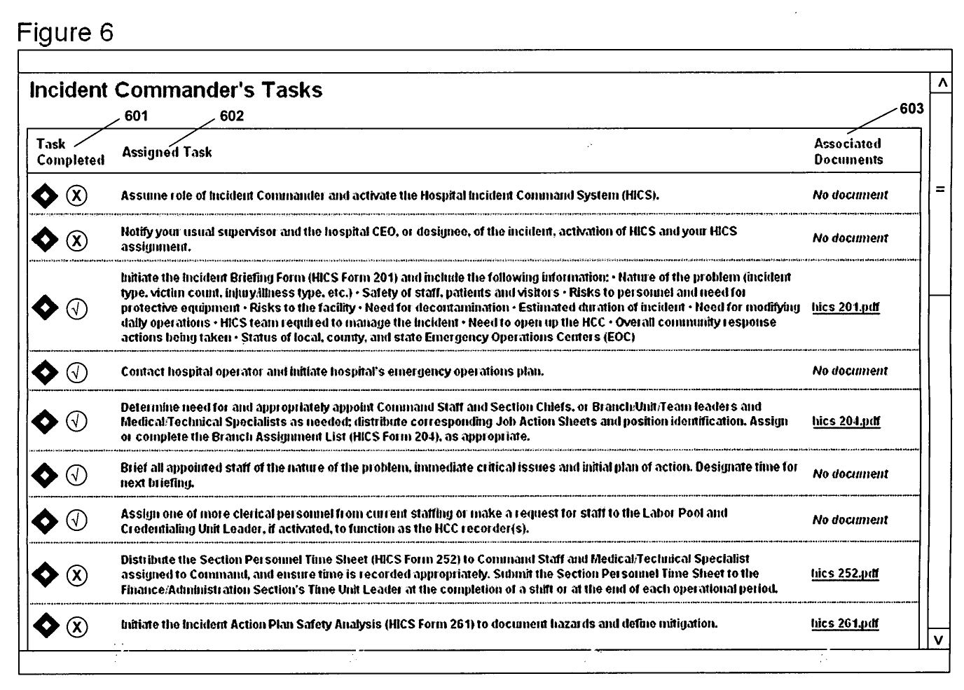

As mentioned before, JAS are configured in the Preparation Module and are displayed to the user in the Response Module. FIG. 6 is a display illustrating a JAS of the system. It illustrates an example of an incident commander's tasks. One or more assigned tasks are shown in column 602. The status of the task (completed or not completed) is shown in column 601. Any associated documents are presented in column 603. The incident commander reads the instructions for each task, performs the task, initiates any required communications for the task, and checks it as done in column 601 when completed. As noted above, an indication by the incident commander of the completion of a task will be automatically updated to other responders and to the auditing capability of the system.

Tasks on the JAS sheet may be further broken down into immediate, intermediate, and extended tasks. This break down may be color coded. In one embodiment, the immediate tasks may be red, the intermediate tasks may be green, and the extended tasks may be blue.

The system allows tasks to be marked as completed by a user. JAS list dynamically updates to reflect which tasks have been completed. In one embodiment, the system keeps track of how long it takes for each task to be marked as “completed,” or any other similar notation. Reports based on how long it took to perform each tasks may be provided in the Reporting Module, which will be discussed in more detail below.

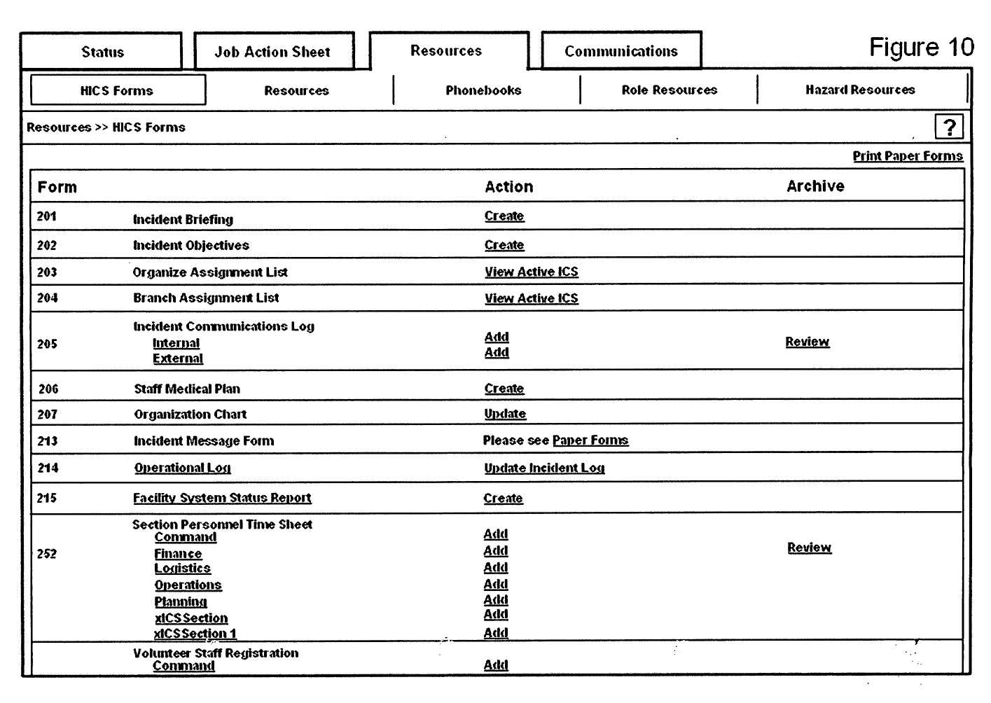

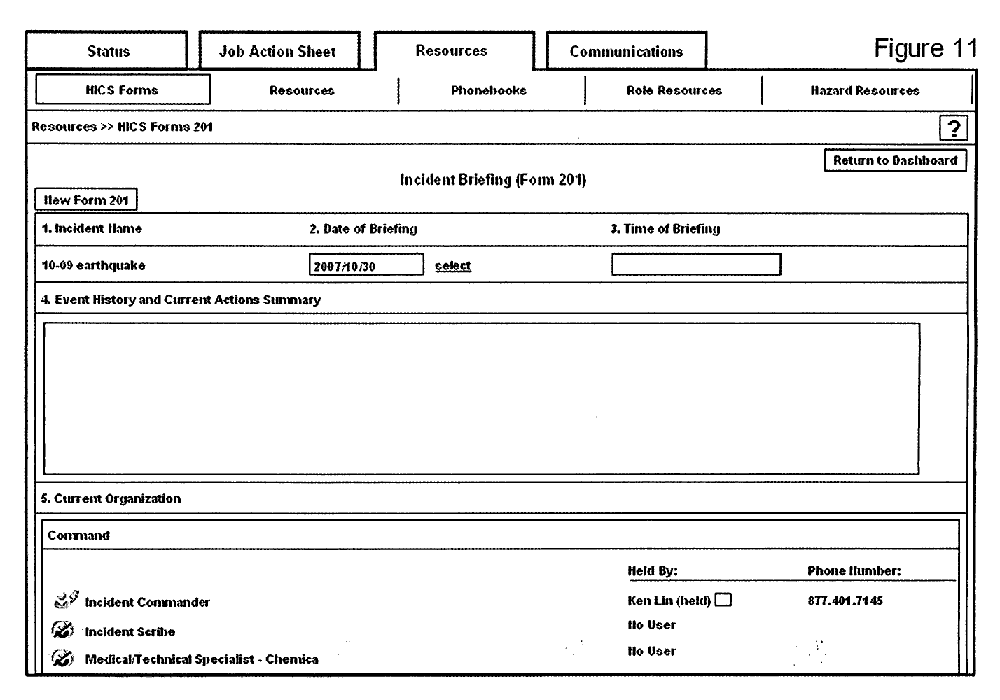

One alternative embodiment extends the JAS and makes it more like a traditional workflow tool. A “My To Do List” page appears with a centralized and prioritized list of all tasks and messages. This allows a user to know at all times what responsibilities need tending to next, what information they need to provide for later auto generation of things like HICS IV forms. For example, form information is automatically sent to ICS role holders who require that information or need a copy of it so they can print it for their records. FIG. 10 shows one possible embodiment of a HICS IV form repository page and FIG. 11 shows a potential electronic representation of the Incident Briefing HICS IV form 201. Having form information automatically populate based on questions the system poses to the user via the “My To Do List” page has significant benefit over the user having to find the right form and fill it in out of the HICS IV task context of why that, information is needed. In this way, creating and updating form information will be an artefact of user interaction in the “My To Do List” page. In this way the system will request required incident information in a simple manner and disseminate that information to all relevant ICS roles. Form information can also be summarized and automatically put into preliminary briefing reports users can access and review before the scheduled briefings in the command centre that HICS IV requires.

Data Sharing

Multiple facilities using the system are able to share data. Such shared data is configurable and may include at least one of the following: bed capacity information, incident command structure (ICS), members of the ICS which are presently on duty or logged on, name of the facility, location of the facility, and facility's presently activated hazard(s), emergency department status, supplies and inventory data.

In addition, different units or departments within one facility are able to share data. Such shared data includes trackable items (configured or setup in the preparation module), bed census information, location-specific documents, and other. The trackable items may be both durable equipment as well as consumable supplies. In further embodiments, units within the facility may share status of requests, as described above, through the requests overview section of the Response Module.

In yet further embodiments, facilities may choose to share information relating to JAS by ICS roles, such as, for example, completion status of the JAS tasks. For example, some or all members of ICS would be able to see the status of JAS tasks for other members of the ICS. For example, the incident commander may be able to see whether the security chief has completed his or her tasks from the JAS.

The data maybe shared across a facility, across a geographic region, across a network of affiliated facilities (e.g. Kaiser, Intermountain Health Care, etc), or across such groups as the user may configure.

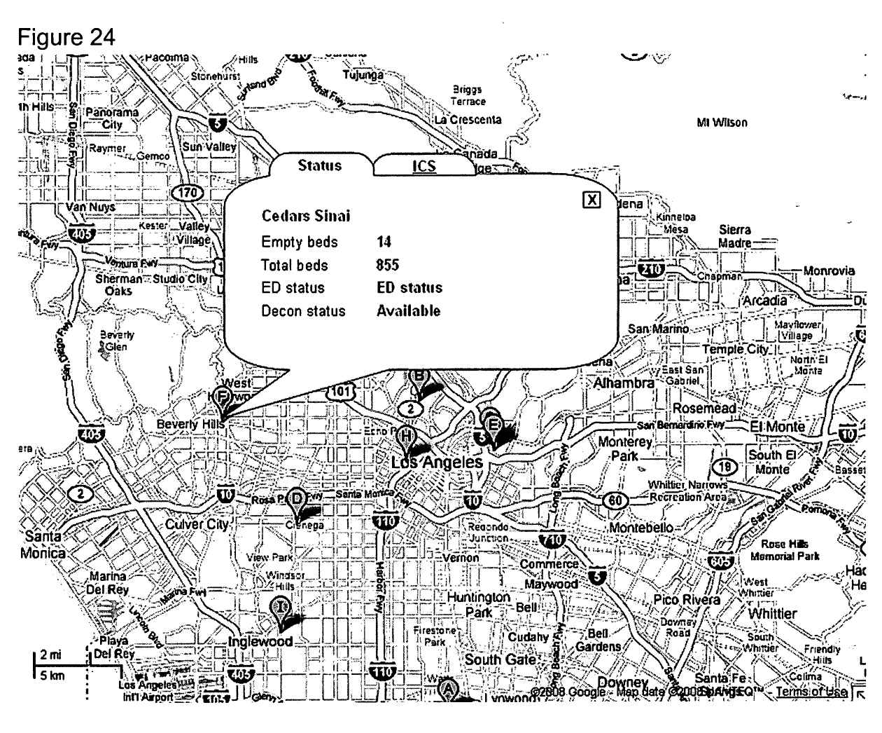

In additional to tables, graphs, and reports based on this data, the system also allows data to be viewed in a GIS (geographic information systems) display such as shown in FIG. 24. In one embodiment, a group of facilities may be defined (based in geographic or other criteria) as well as what data about each facility to display (e.g. Incident status, ED status, ICS commander contact information, supplies, bed availability, etc), the conditions under which each data type should be provided (incident type, phase, etc), and a map will be displayed the specified information.

Reference Library

The reference library in the Response Module displays the references (if any) uploaded or added in the Prepare Module. In addition, references may be displayed along with JAS for which they were uploaded. In further embodiments, new or additional references may be uploaded in the Response Module.

Data Collection

In one embodiment the incident commander or any other ICS role authorized to do so, issues a request for data to be reported. Users holding roles responsible for reporting for specific departments and/or units enter the data regarding items being tracked. The items being tracked are configured in the Prepare Module and may include personnel and capacity items. such as, for example, nurses, technicians, available beds, missing patients, admitted patients, available equipment, etc. such as using the system described in FIG. 2 above.

Recovery Module (1304)

The recovery Module 1304 of the system provides a way for users to conduct an incident audit and provides users with a variety of reports relating to the incident. The Recovery Module also displays a copy of the incident log created during the incident.

Incident Audit

The Recovery Module of the system provides an ability to conduct an incident audit. To conduct an incident audit, first, an incident is selected. The selected incident will be the audited incident. In alternative embodiments, the incident to be audited may be automatically selected, predetermined, or determined based on any other criteria. Further embodiments allow analysis of the data associated with multiple incidents and/or facilities.

As part of an incident audit, users can create an incident report. In one embodiment, there will be one report per user. An incident report comprises a report summary, a role or roles held by the report author during the incident, and a list of improvement suggestions. An improvement suggestion is a suggestion by the user related to improvement of facility's response to hazards, which may be converted into an improvement task. For example, after an incident, the security chief may add a request that more flash lights be stocked in the command center as an improvement suggestion.

In one embodiment users of the system may review all improvement suggestions and create or assign improvement tasks to address at least one improvement suggestion. In the example above, a task for acquiring and stocking additional flash lights in the command center may be added. The improvement task consists of a task description, task urgency, completion status, task owner, and an estimated date of completion. In other embodiments, improvement tasks may comprise any attribute of a task to be performed.

The Recovery Module provides a convenient top-level view of tasks for improved response comprising all outstanding and completed improvement tasks.

Reports

In one embodiment, the system can provide at least one report for any given incident. The at least one report comprises: task completion report, requests report, hospital capacity report, personnel over time report, and data collection report.

Task Completion Report

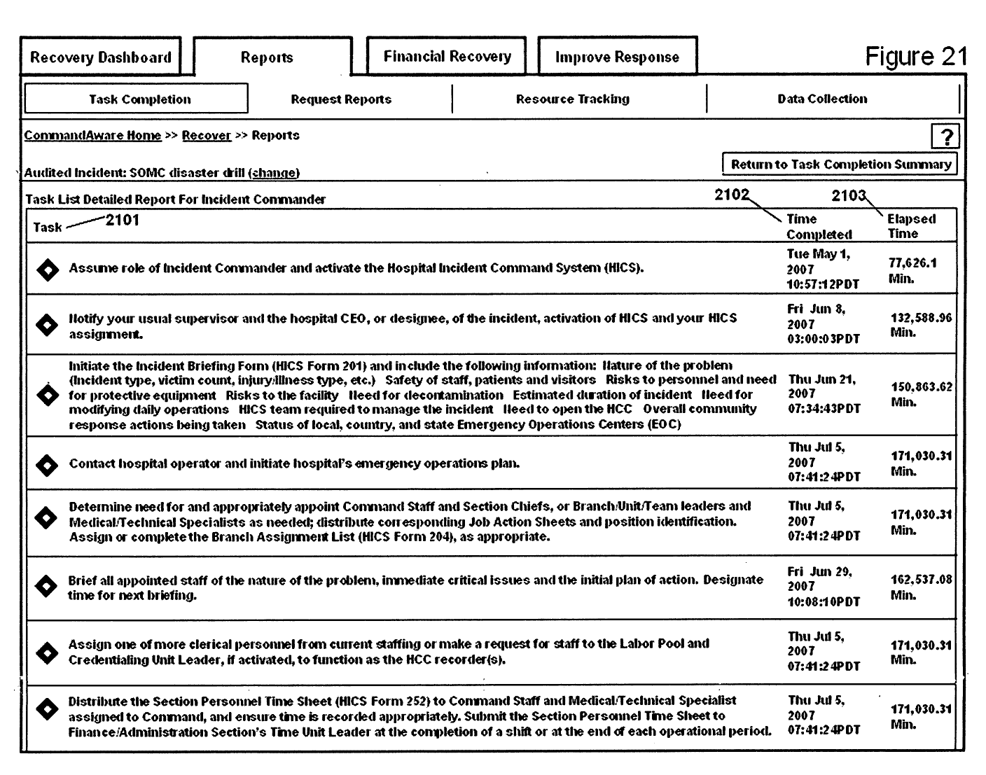

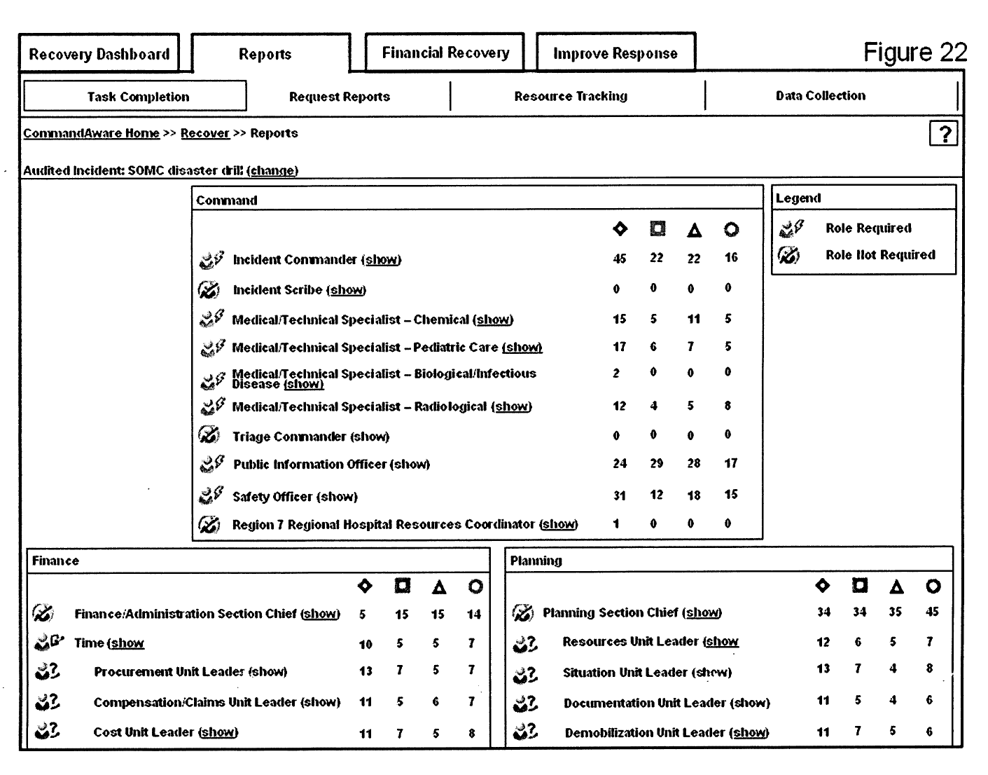

A task completion report includes information on the status of JAS tasks for each ICS role. The report includes information on whether a particular task was or was not completed. In the preferred embodiment, the report also includes the time when the task was marked completed and the time elapsed from the start of the incident until the task was marked completed. Report information on JAS sheets in one embodiment is broken down by the ICS roles. FIG. 21 is an example of a report for an incident commander. The report includes column 2101 of tasks assigned to the incident commander, column 2102 of the time stamp of completion of the task, and column 2103 of the elapsed time between response initiation and task completion. FIG. 22 is an example of a report for ICS. This report displays a summary for a plurality of responders and indicates the number of tasks and number of completed tasks for each responder.

Request Report

A request report includes a report regarding at least one of the following: logistics requests, materials requests, personnel requests. In one embodiment, the request report comprises the request description, sender of the request, time the request was made, status of the request, if completed, the length of time it took to complete, the time the request was acknowledged, and the time the request was completed. In further embodiments, the request report may contain the role of the sender, the location of the sender, the name, location and/or role of the user completing the request, and additional request details.

Hospital Capacity

In on example of the system as used in a hospital environment, a hospital capacity report provides information on the capacity of the facility using the system over the time of an incident. Facility capacity s expressed in terms of bed count. In one embodiment, the hospital capacity report contains graphical representations, such as, for example, line graphs, of bed count over time for each department of the facility. The reports can further be broken down by department units.

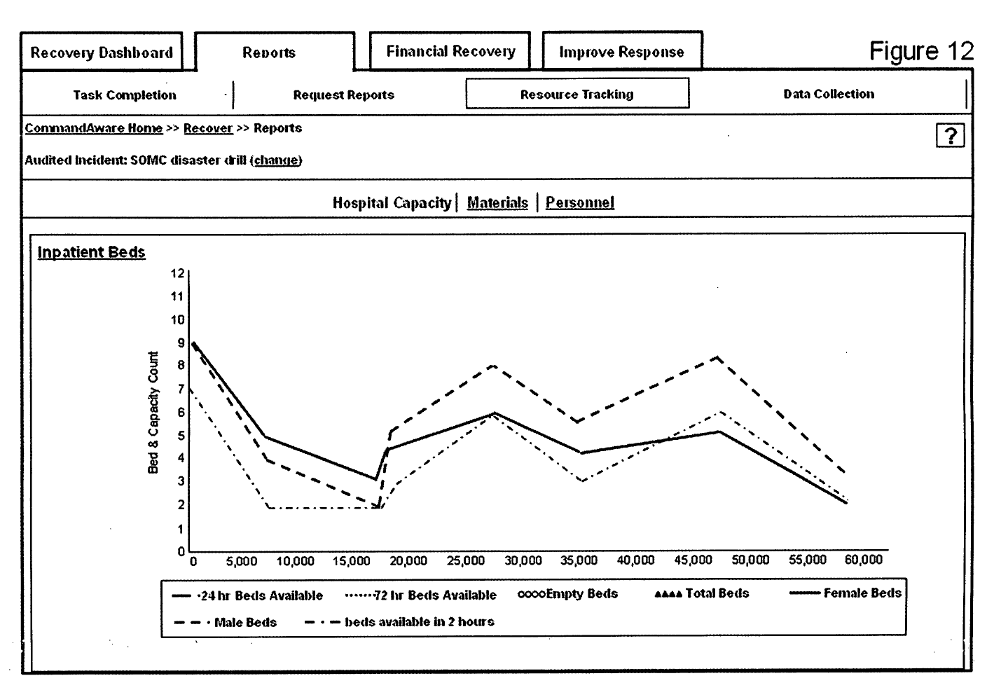

Bed count information may be displayed for all or part of the capacity data collected in the Response Module. For example, bed count may show a count of the 24 hr beds available, 72 hr beds available, empty beds, total beds, female beds, male beds, dirty beds, ghost beds, etc. as illustrated in FIG. 12.

Personnel Over Time

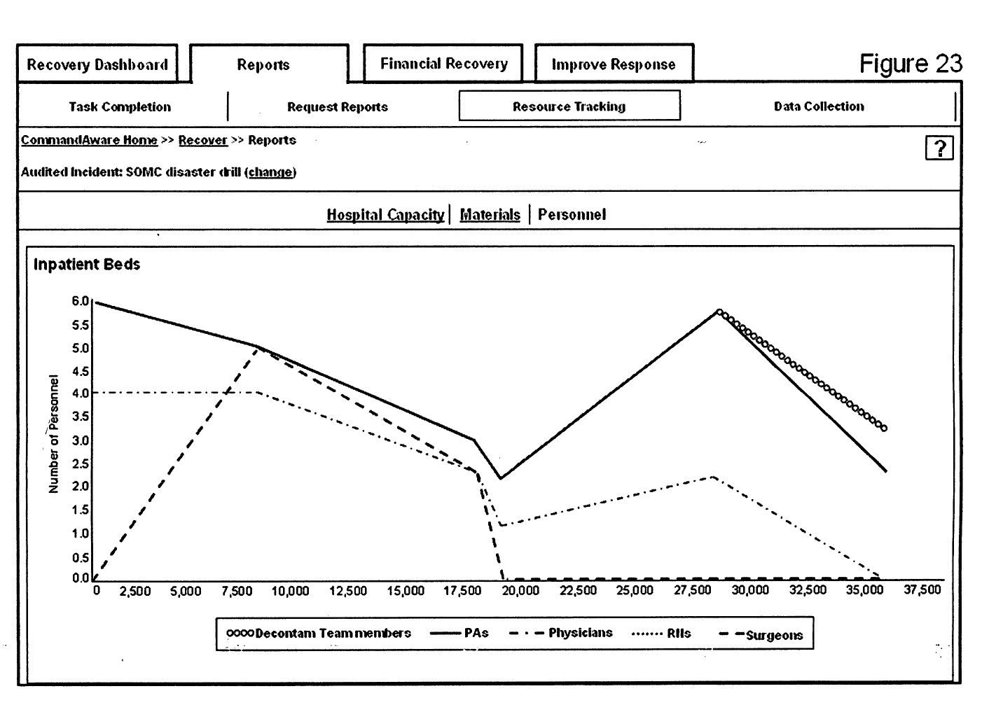

A personnel over time report provides information on number of available personnel at the user's facility over the time of the incident being audited. In the preferred embodiment, the personnel over time report provides a line graph where the x-axis represents duration from the start of the incident and the y-axis represents the number of personnel in one or more of the tracked personnel units. The tracked personnel units are configured in the Prepare Module, and may be any unit a facility wants to track. For example, a facility may choose to track the number of decontamination team members, physician assistants, registered nurses, and surgeons on staff such as in FIG. 23.

Data Collection

A data collection report contains information regarding each unit's request to the data collection requests, if any, issued during the Respond Module. In general, the data collection report displays a number of points collected by each unit and amount of time it took for each unit to respond to the data collection request. In the preferred embodiment, the data collection report contains request time (the time the request for data entry was made), data entry time (the time the data was entered, into the system, if any), and the time elapsed from request to entry.

Financial Recovery Task Lists

The Recovery Module provides steps for creating and tracking action items related to financial recovery. In one embodiment, users can create task lists relating to business coverage, cash flow, emergency response, supplies, and employees. Bach task in the task list contains at least one of the following: a task description, a task priority, completion status, person responsible, date completed, if any, and notes. As the tasks are completed, users may change the status of the task in the financial recovery task list. In one embodiment, the Recovery Module provides an overview of the number and categories of outstanding tasks,

### Embodiment of Computer Execution Environment (Hardware)

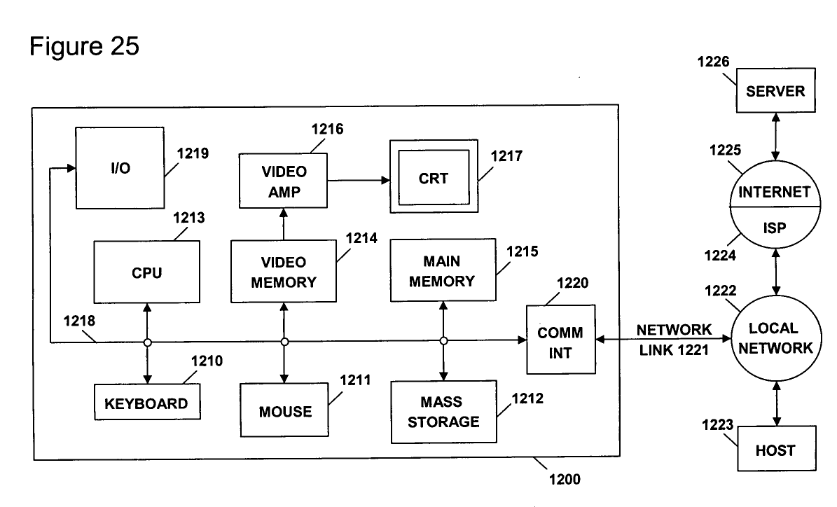

An embodiment of the system can be implemented as computer software in the form of computer readable program code executed in a general purpose computing environment such as environment 2500 illustrated in FIG. 25, or in the form of bytecode class files executable within a Java™ run time environment running in such an environment, or in the form of bytecodes running on a processor (or devices enabled to process bytecodes) existing in a distributed environment (e.g., one or more processors on a network). The system may also be implemented on any suitable computing device such as a PDA, mobile phone, mobile computing device, as a software service hosted on a server, an ethereal network based implementation, or any other suitable processing environment.

In the system of FIG. 25, a keyboard 1210 and mouse 1211 are coupled to a bidirectional system bus 1218. The keyboard and mouse are for introducing user input to the computer system and communicating that user input to central processing unit (CPU) 1213. Other suitable input devices may be used in addition to, or in place of, the mouse 1211 and keyboard 1210. I/O (input/output) unit 1219 coupled to bidirectional system bus 1218 represents such I/O elements as a printer, A/V (audio/video) I/O, etc,

Computer 1200 includes a video memory 1214, main memory 1215 and mass storage 1212, all coupled to bi-directional system bus 1218 along with keyboard 1210, mouse 1211 and CPU 1213. The mass storage 1212 may include both fixed and removable media, such as magnetic, optical or magnetic optical storage systems or any other available mass storage technology. Bus 1218 may contain, for example, thirty-two address lines for addressing video memory 1214 or main memory 1215. The system bus 1218 also includes, for example, a 32-bit data bus for transferring data between and among the components, such as CPU 1213, main memory 1215, video memory 1214 and mass storage 1212. Alternatively, multiplex data/address lines may be used instead of separate data and address lines.

In one or more embodiments of the invention, CPU 1213 is a microprocessor manufactured by Motorola, such as the 680X0 processor or a microprocessor manufactured by Intel, such as the 80X86, or Pentium processor, or a SPARC microprocessor from Sun Microsystems. However, any other suitable microprocessor or microcomputer may be utilized. Main memory 1215 is comprised of dynamic random access memory (DRAM).

Video memory 1214 is a dual-ported video random access memory. One port of the video memory 1214 is coupled to video amplifier 1216. The video amplifier 1216 is used to drive the cathode ray tube (CUT) raster monitor 1217. Video amplifier 1216 is well known in the art and may be implemented by any suitable apparatus. This circuitry converts pixel data stored in video memory 1214 to a raster signal suitable for use by monitor 1217. Monitor 1217 is a type of monitor suitable for displaying graphic images.

Computer 1200 may also include a communication interface 1220 coupled to bus 1218. Communication interface 1220 provides a two-way data communication coupling via a network link 1221 to a local network 1222. For example, if communication interface 1220 is an integrated services digital network (ISDN) card or a modem, communication interface 1220 provides a data communication connection to the corresponding type of telephone line, which comprises part of network link 1221. If communication interface 1220 is a local area network (LAN) card, communication interface 1220 provides a data communication connection via network link 1221 to a compatible LAN. Wireless links are also possible. In any such implementation, communication interface 1220 sends and receives electrical, electromagnetic or optical signals which carry digital data streams representing various types of information.

Network link 1221 typically provides data communication through one or more networks to other data devices. For example, network link 1221 may provide a connection through local network 1222 to host computer 1223 or to data equipment operated by an Internet Service Provider (ISP) 1224. ISP 1224 in turn provides data communication services through the world wide packet data communication network now commonly referred to as the “Internet” 1225. Local network 1222 and Internet 1225 both use electrical, electromagnetic or optical signals which carry digital data streams. The signals through the various networks and the signals on network link 1221 and through communication interface 1220, which carry the digital data to and from computer 1200, are exemplary forms of carrier waves transporting the information.

Computer 1200 can send messages and receive data, including program code, through the network(s), network link 1221, and communication interface 1220. In the Internet example, server 1226 might transmit a requested code for an application program through Internet 1225, ISP 1224, local network 1222 and communication interface 1220. In accord with the invention, one such downloaded application is the method and apparatus for creating, editing and displaying works containing time-dimensioned textual components described herein.

The received code may be executed by CPU 1213 as it is received, and/or stored in mass storage 1212, or other non-volatile storage for later execution. In this manner, computer 1200 may obtain application code in the form of a carrier wave.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the system may be implemented in any type of computer system or programming or processing environment.

Thus, a system and method for creating software applications has been described.

What is claimed is:

1. A method of responding to an incident in a facility comprising:
determining an incident requiring a response;
retrieving data concerning a current status of the facility;
determining one or more responders based on the current stains;
dynamically generating job actions for responding to the incident based on the current status.

2. The method of claim 1 further including the step of dynamically assigning the job actions to the one or more responders based on the current status.

3. The method of claim 2 further including the step of monitoring the one or more responders to determine the status of die job actions.

4. The method of claim 3 further including the step of defining communication paths between the one or more responders based on the current status.

5. The method of claim 4 further including the steps of receiving requests during the response and providing replies to the requests.

6. The method of claim 1 further including providing and sharing data with another facility.

7. A method for responding to an incident comprising:
determining an incident requiring a response;
determining available responders to the incident;
configuring a display for each responder of the available responders dependent on the role of each responder;
identifying each responder by one or more of name, role, and location;
providing communication between responders using one or more of name, role, and location.

8. A method of generating job actions comprising:
determining a current status of a facility;
determining responders present at the facility
dynamically generating job actions as a list of tasks to be completed by a responder for each responder in the facility based on the current status.

9. The method of claim 8 wherein the job actions vary depending on the status of responders.

10. A method of sharing data between a first and second facility comprising:
providing a network between the facilities;
sharing data between the facilities based on a current status of one of the facilities;
where the data includes asset information, personnel availability, responder availability, and supply status.

11. The method of claim 10 wherein further facilities provide status to the facilities.

12. The method of claim 11 wherein one facility can request assets from other facilities.

13. A method of managing reference materials in a facility comprising:
retrieving data concerning a current status of the facility;
determining reference information required based on the status of facility;
making the reference information available.
